(19) United States
(12) Patent Application Publication
(10) Pub. No.: US 2017/0090249 A1
(43) Pub. Date: Mar. 30, 2017

(54) DISPLAY PANEL, METHOD FOR DRIVING THE SAME, AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Kun LU, Beijing (CN); Ling BAI, Beijing (CN); Juan WANG, Beijing (CN); You LI, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/248,733

(22) Filed: Aug. 26, 2016

(30) Foreign Application Priority Data
Sep. 25, 2015 (CN) 201510623094.2

(51) Int. Cl. G02F 1/1335; G02F 1/1343; G02F 1/133

(52) U.S. Cl. CPC G02F 1/133621; G02F 1/13306; G02F 1/133514; G02F 1/134309; G02F 2201/52; G02F 2202/36; G02F 2001/133614; G02F 2203/05; G02F 2001/134345; G02F 1/1368

(57) ABSTRACT

A backlight of a display panel includes a blue light source, a green light source and a red light emitting layer above the green and blue light sources. The red light emitting layer emits red light when being irradiated by blue light and emits no light when being irradiated by green light. The display panel further includes a control circuit, which controls the blue light source to be turned on in a first period of time, controls the green light source to be turned on in a second period of time, and controls the red liquid crystal cell, the green liquid crystal cell and/or the blue liquid crystal cell to be turned on and/or turned off in the first period of time and/or the second period of time according to a color to be displayed by a target pixel.

### CROSS-REFERENCE TO RELATED APPLICATION

The present application claims a priority to Chinese Patent Application No. 201510623094.2 filed on Sep. 25, 2015, the disclosure of which is incorporated in its entirety herein by reference.

### FIELD

The present disclosure relates to the field of displaying technologies, and in particular, to a display panel, a display device and a method for driving a display panel.

### BACKGROUND

As shown in FIG. 2, in a liquid crystal display in related technologies, a backlight is usually provided as a blue chip 41 and a yellow fluorescent layer 42 cooperating with each other, and a color filter usually includes a red filtering film 211, a green filtering film 221 and a blue filtering film 231. Each pixel includes a blue sub-pixel, a green sub-pixel and a red sub-pixel, and colorful displaying is achieved by controlling a liquid crystal layer 2 facing the three sub-pixels.

As shown in FIG. 1, the spectrum of green light overlaps each of the spectrum of blue light and the spectrum of red light; hence when using the color filter in the related technologies to filter and distinguish the red light, green light and blue light, unwanted colorful light cannot be effectively filtered out in respective pixel areas and a part of the unwanted colorful light may pass through the color filter.

FIGS. 2-4 show leakage of unwanted colorful light in respective cases that the blue light, the green light and the red light are wanted. As shown in FIG. 2A, a liquid crystal cell corresponding to the blue sub-pixel is turned on. As shown in FIG. 2B, light having a wavelength ranging from 380 nm to 500 nm can pass through the blue filtering film 231. Although the range from 380 nm to 500 nm corresponds to the blue light, the green light may have a wavelength ranging from 470 nm to 500 nm; hence, a part of the green light can pass through the blue filtering film and the leakage of the green light is caused. As shown in FIG. 2C, lights passing through the light filtering film 231 contain some green light, the color gamut is decreased. In addition, as shown in FIGS. 3A-3C, lights passing through the green filtering film 221 contain some blue light, and as shown in FIGS. 4A-4C, lights passing through the red filtering film 211 contain some green light; in both cases, the leakage of unwanted colorful light takes place.

### SUMMARY

The present disclosure provides a display panel, a display device and a method for driving a display panel, which can avoid the leakage of unwanted colorful light of display panels.

The present disclosure provides a display panel, including a backlight, a red liquid crystal cell corresponding to a red sub-pixel of each pixel, a green liquid crystal cell corresponding to a green sub-pixel of each pixel and a blue liquid crystal cell corresponding to a blue sub-pixel of each pixel, the red, green and blue liquid crystal cells being arranged above the backlight. The backlight includes a blue light source, a green light source and a red light emitting layer arranged above the blue light source and the green light source, the red light emitting layer emits red light when being irradiated by blue light and does not emit any light when being irradiated by green light.

The display panel further includes a control circuit, adapted to control the blue light source to be turned on in a first period of time, control the green light source to be turned on in a second period of time, and control the red liquid crystal cell, the green liquid crystal cell and/or the blue liquid crystal cell to be turned on and/or turned off in the first period of time and/or the second period of time according to a color to be displayed by a target pixel.

Optionally, when the target pixel is to display in red, the red liquid crystal cell corresponding to the target pixel is controlled to be turned on in the first period of time, and the blue liquid crystal cell and the green liquid crystal cell corresponding to the target pixel are controlled to be turned off.

Optionally, when the target pixel is to display in green, the green liquid crystal cell corresponding to the target pixel is controlled to be turned on in the second period of time, and the blue liquid crystal cell and the red liquid crystal cell corresponding to the target pixel are controlled to be turned off.

Optionally, when the target pixel is to display in blue, the blue liquid crystal cell corresponding to the target pixel is controlled to be turned on in the first period of time, and the red liquid crystal cell and the green liquid crystal cell corresponding to the target pixel are controlled to be turned off.

Optionally, a length of the first period of time equals to that of the second period of time.

Optionally, the length of each of the first period of time and the second period of time equals to 7 ms.

Optionally, a sum of the first period of time and the second period of time is smaller than duration of visual persistence.

Optionally, the red light emitting layer includes a red quantum dot material and/or a red fluorescent material.

Optionally, the red liquid crystal cell includes a red filtering film, the blue liquid crystal cell includes a blue filtering film and the green liquid crystal cell includes a transparent thin film.

Optionally, each of the red liquid crystal cell, the blue liquid crystal cell and the green liquid crystal cell includes a corresponding liquid crystal layer, and the control circuit controls states of liquid crystals in each liquid crystal layer to turn on and turn off each liquid crystal cell.

The present disclosure further provides a display device, including the above mentioned display panel.

The present disclosure further provides a method for driving the above mentioned display panel, including: controlling the blue light source to be turned on in the first period of time and controlling the green light source to be turned on in the second period of time; and controlling the red liquid crystal cell, the green liquid crystal cell and/or the blue liquid crystal cell to be turned on and/or turned off in the first period of time and/or the second period of time according to the color to be displayed by the target pixel.

Optionally, when the target pixel is to display in red, the red liquid crystal cell corresponding to the target pixel is controlled to be turned on in the first period of time, and the blue liquid crystal cell and the green liquid crystal cell corresponding to the target pixel are controlled to be turned off.

Optionally, when the target pixel is to display in green, the green liquid crystal cell corresponding to the target pixel is controlled to be turned on in the second period of time, and the blue liquid crystal cell and the red liquid crystal cell corresponding to the target pixel are controlled to be turned off.

Optionally, when the target pixel is to display in blue, the blue liquid crystal cell corresponding to the target pixel is controlled to be turned on in the first period of time, and the red liquid crystal cell and the green liquid crystal cell corresponding to the target pixel are controlled to be turned off.

In the technical solutions of the present disclosure, the red light emitting layer cooperates with the blue light source and the green light source. When the blue light source is turned on, a part of blue light irradiates the red light emitting layer and excites the red light emitting layer to emit red light, and another part of blue light passes through the red light emitting layer, such that the backlight can emit red light and blue light in the first period of time; when a corresponding liquid crystal cell is turned on, lights entering a color filtering layer via the liquid crystal cell contain only the blue light and the red light. Since spectrums of the blue light and the red light do not overlap, each of the blue light and the red light emitted out of the color filtering layer barely contains light of other color. When the green light source is turned on, green light can pass through the red light emitting layer and the backlight emits the green light in the second period of time; when a corresponding liquid crystal cell is turned on, light entering the color filtering layer via the liquid crystal cell contains only the green light; hence, light passing through the color filtering layer contains only the green light and contains no other colorful light. In this way, leakage of unwanted colorful light is avoided, thereby increasing the gamut of the color displayed by the pixel.

### BRIEF DESCRIPTION OF THE DRAWINGS

Characteristics and advantages of the present disclosure may be better understood in conjunction with drawings. The drawings are exemplary and are not intended to limit the present disclosure. Among the drawings,

FIG. 1 illustrates the fact that the spectrum of green light overlaps the spectrum of red light and the spectrum of blue light in related technologies;

FIGS. 2A-2C illustrate leakage of unwanted colorful light in the case that a pixel is to display in blue in related technologies;

FIGS. 3A-3C illustrate leakage of unwanted colorful light in the case that a pixel is to display in red in related technologies;

FIGS. 4A-4C illustrates leakage of unwanted colorful light in the case that a pixel is to display in green in related technologies;

FIG. 5 is a schematic structural diagram of a display panel according to one embodiment of the present disclosure;

FIGS. 6A-6C illustrate how to avoid leakage of unwanted colorful light in the case that a pixel is to display in red according to one embodiment of the present disclosure;

FIGS. 7A-7C illustrate how to avoid leakage of unwanted colorful light in the case that a pixel is to display in green according to one embodiment of the present disclosure;

FIGS. 8A-8C illustrate how to avoid leakage of unwanted colorful light in the case that a pixel is to display in blue according to one embodiment of the present disclosure;

FIG. 9 is schematic structural diagram of a display panel according to one embodiment of the present disclosure;

FIG. 10 is a flow chart of a method for driving a display panel according to one embodiment of the present disclosure.

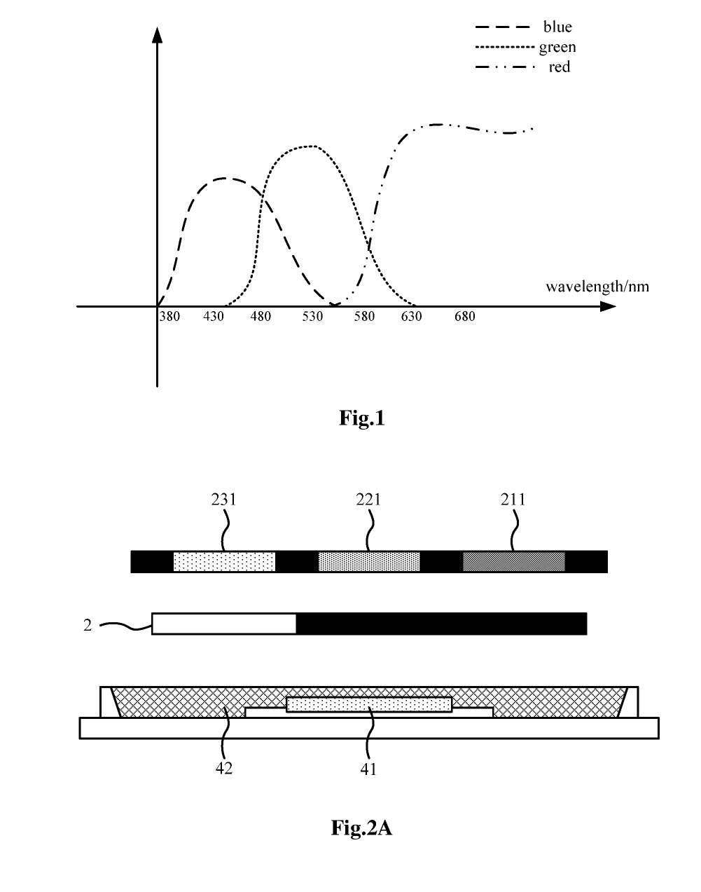

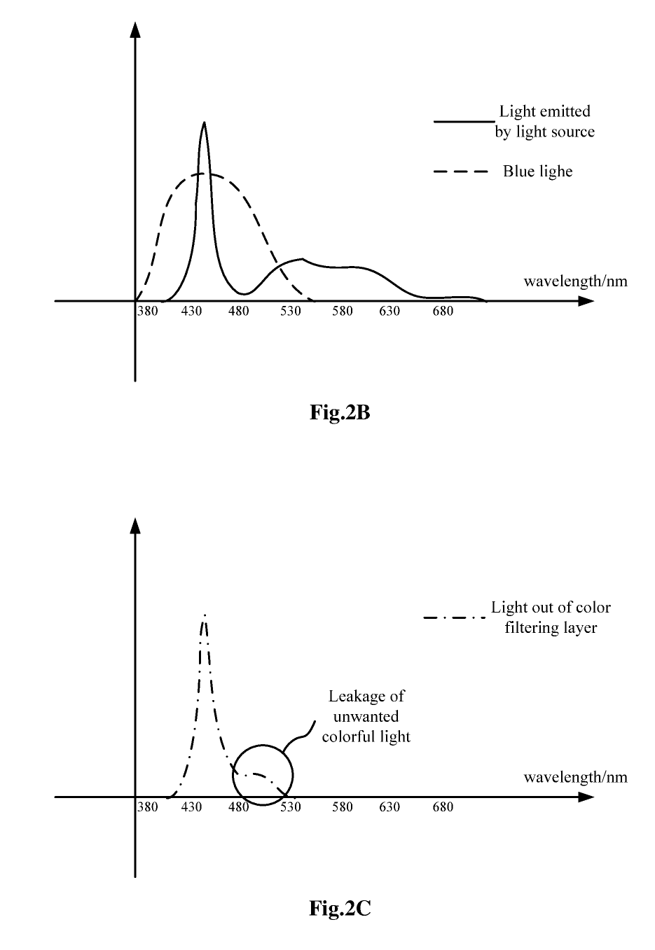

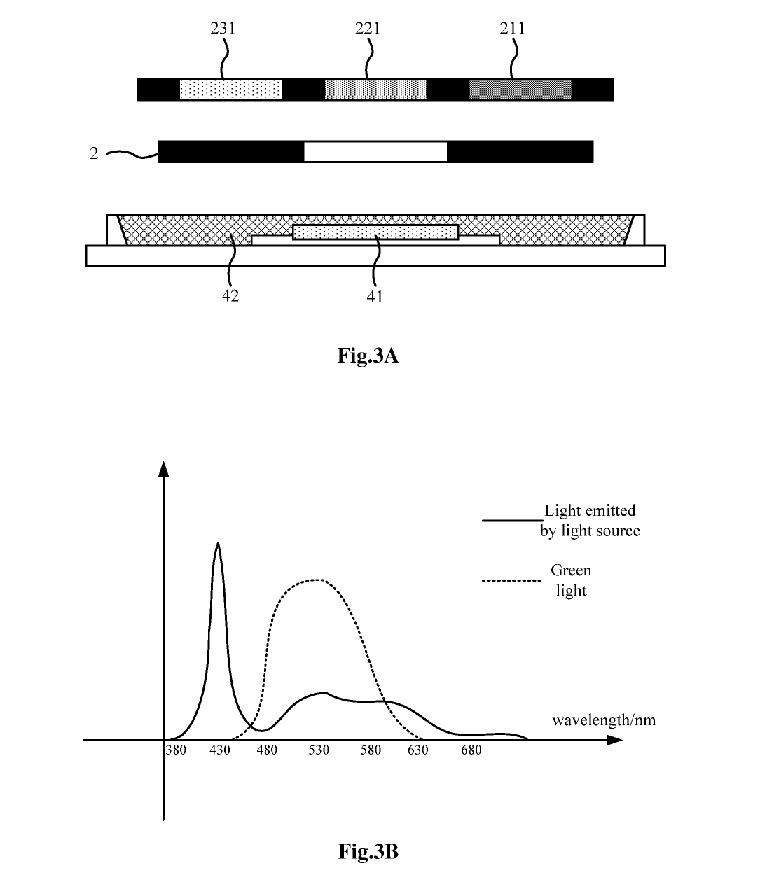

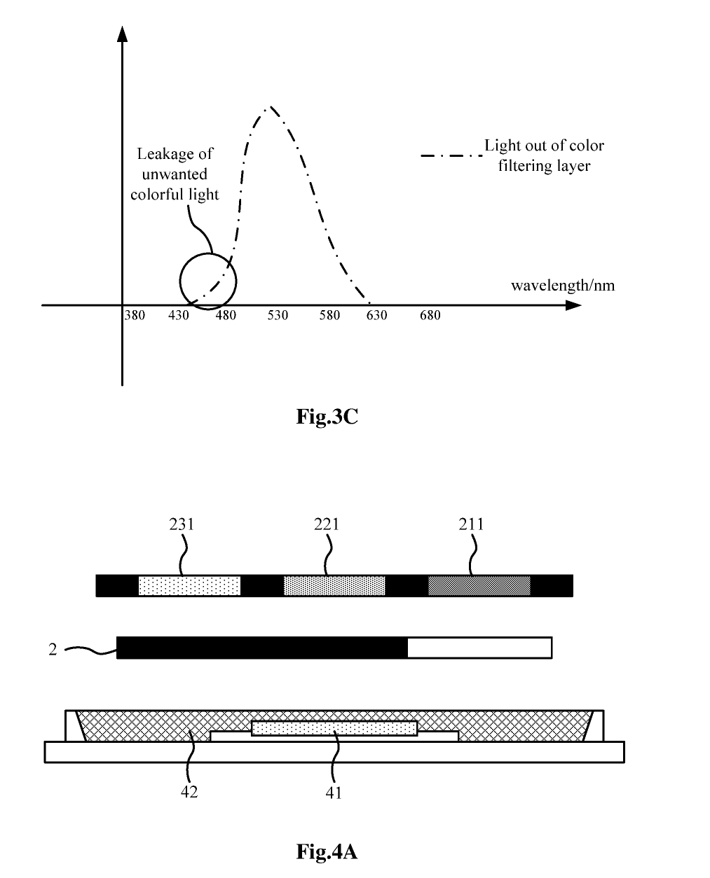

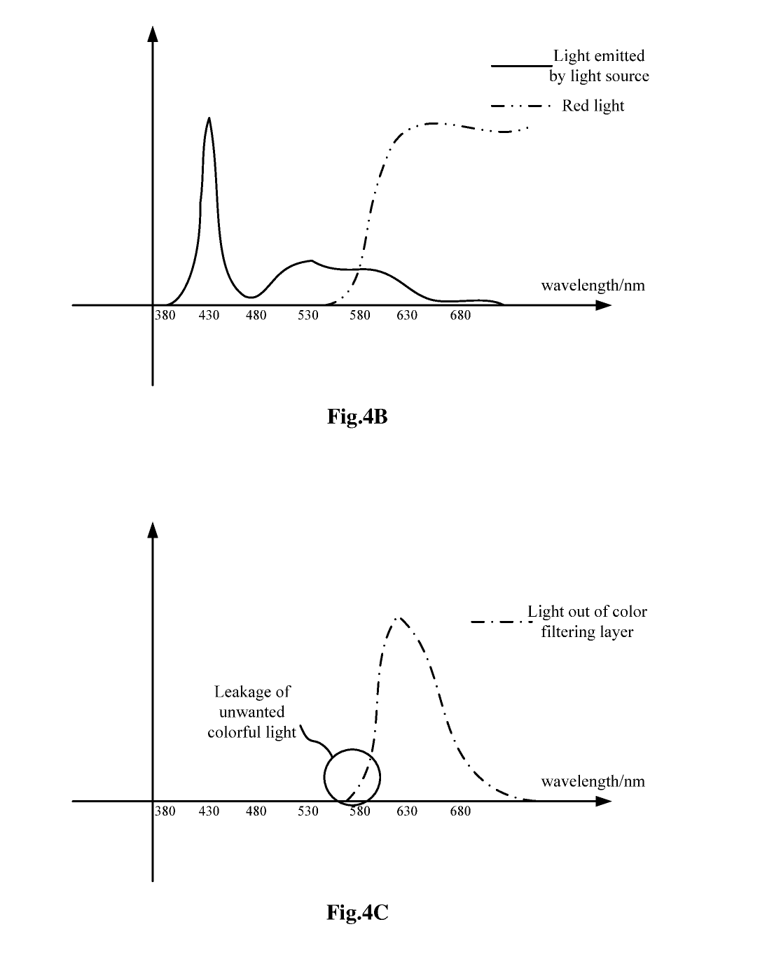

### NUMERAL REFERENCES

1: backlight 11:blue light source 12:green light source 13: red light emitting layer 2: liquid crystal layer 21: red liquid crystal cell 22: green liquid crystal cell 23: blue liquid crystal cell 211: red filtering film 221: green filtering film 231: blue filtering film 222: transparent thin film 41: blue chip 42: yellow fluorescent layer.

### DETAILED DESCRIPTION OF THE EMBODIMENTS

For better understanding objectives, characteristics and advantages of the present disclosure, detailed description is given hereinafter in conjunction with drawings and specific embodiments. It should be noted that, the embodiments of the present disclosure and the characteristics of the embodiments can be combined if no collision may be caused by the combination.

Lots of details are illustrated in the following description for fully understanding the present disclosure. The present disclosure can be implemented with approaches other than those described in the specification, and the specific embodiments disclosed herein are not to limit the protection scope of the present disclosure.

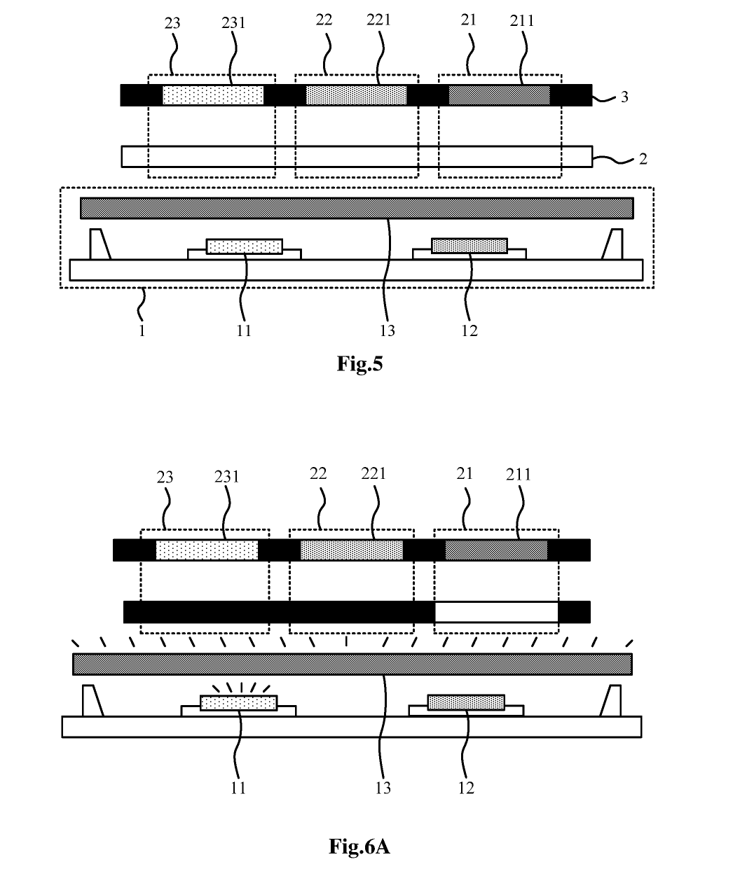

As shown in FIG. 5, a display panel according to one embodiment of the present disclosure includes: a backlight 1, and a red liquid crystal cell 21 corresponding to a red sub-pixel of each pixel, a green liquid crystal cell 22 corresponding to a green sub-pixel of each pixel and a blue liquid crystal cell 23 corresponding to a blue sub-pixel of each pixel, those liquid crystal cells being arranged above the backlight 1. The backlight 1 includes a blue light source 11, a green light source 12 and a red light emitting layer 13 arranged above the blue light source 11 and the green light source 12. The red light emitting layer 13 emits red light when being irradiated by blue light and does not emit any light when being irradiated by green light.

The display panel further includes a control circuit, adapted to control the blue light source 11 to be turned on in a first period of time, control the green light source 12 to be turned on in a second period of time, and control the red liquid crystal cell 21, the green liquid crystal cell 22 and/or the blue liquid crystal cell 23 to be turned on and/or turned off in the first period of time and/or the second period of time according to a color to be displayed by a target pixel. Each liquid crystal cell may include a liquid crystal layer and a color filtering film corresponding to the sub-pixel and a thin film transistor, and the control circuit may control the state of liquid crustal in the liquid crystal layer via the thin film transistor, thereby turning on or turning off a corresponding liquid crystal cell.

The blue light source 11 and the green light source 12 each may cooperate with the red light emitting layer 13. When the blue light source 11 is turned on, a part of blue light irradiating the red light emitting layer 13 excites the red light emitting layer 13 to emit red light, and another part of blue light passes through the red light emitting layer 13. Hence, in the first period of time, the backlight 1 emits both the red light and the blue light. If a corresponding liquid crystal cell is turned on, lights entering a color filtering layer 3 via the liquid crystal cell contain only the blue light and the red light. Since spectrums of the blue light and the red light do not overlap, each of the blue light and the red light emitted out of the color filtering layer 3 barely contains light of other color.

When the green light source 12 is turned on, green light can pass through the red light emitting layer 13 and the backlight 1 emits the green light in the second period of time. If a corresponding liquid crystal cell is turned on, light entering the color filtering layer 3 via the liquid crystal cell contains only the green light; hence, light passing through the color filtering layer contains only the green light and contains no other colorful light. In this way, leakage of unwanted colorful light is avoided during the pixel emits light, thereby increasing the gamut of the color displayed by the pixel.

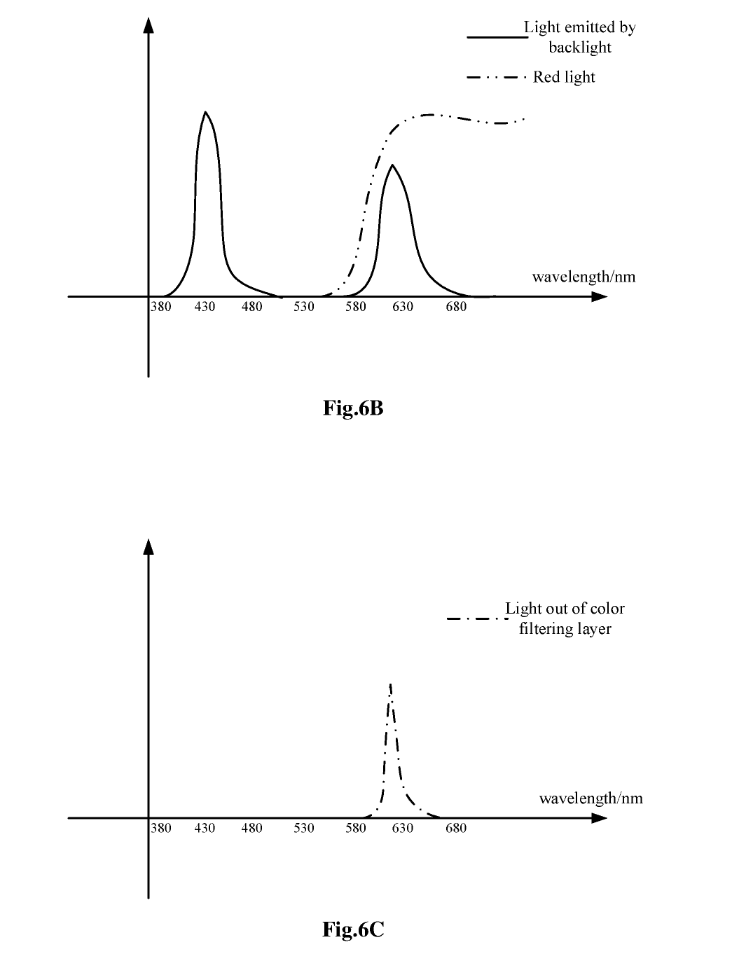

Optionally, as shown in FIG. 6A, if the target pixel is to display in red, the red liquid crystal cell 21 corresponding to the target pixel is controlled to be turned on in the first period of time and the blue liquid crystal cell 23 and the green liquid crystal cell 22 corresponding to the target pixel are controlled to be turned off.

In the first period of time, the blue light source 11 is turned on. A part of blue light irradiates the red light emitting layer 13 and the red light emitting layer 13 is excited to emit red light, another part of blue light passes through the red light emitting layer 13. In the first period of time, the backlight 1 emits the red light and the blue light.

Since in the first period of time only the red liquid crystal cell 21 corresponding to the red sub-pixel is turned on, the red light and the blue light contained in light emitted by the backlight can both enter the color filtering layer via the red liquid crystal cell 21. As shown in FIG. 6B, the red filtering film 211 corresponding to the red liquid crystal cell 21 may filter out light having a wavelength smaller than 550 nm and the blue light emitted by the backlight does not include any component having a wavelength larger than 550 nm, consequently, only the red light emitted by the backlight can pass through the color filtering layer. As shown in FIG. 6C, light emitted by the pixel only contains the red light and no leakage of unwanted colorful light takes place.

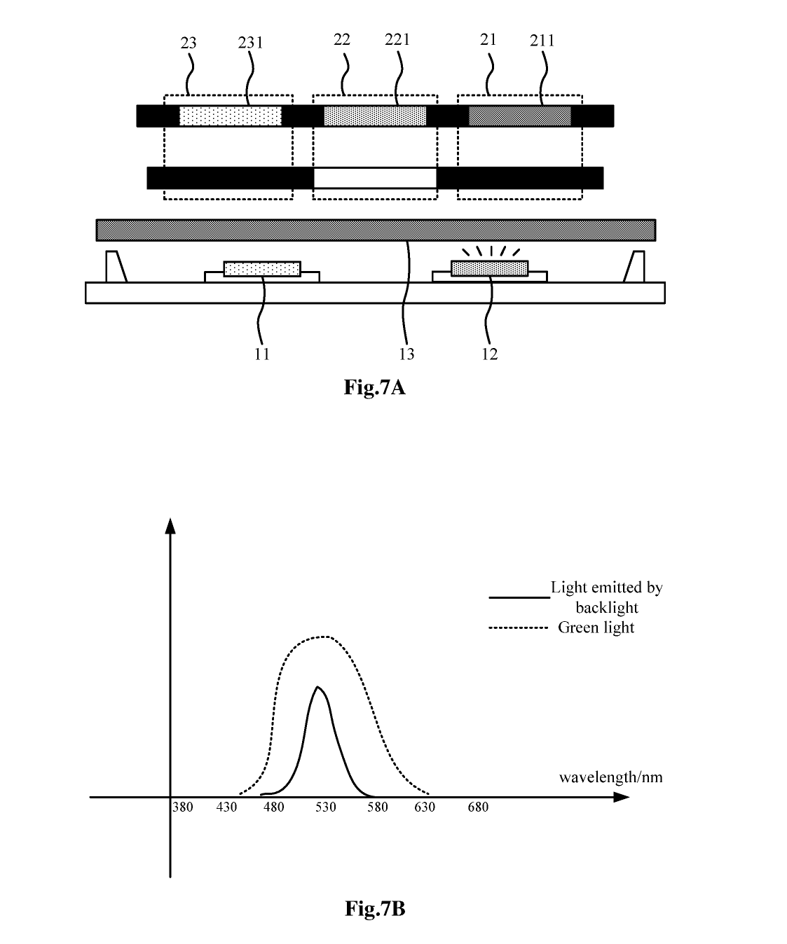

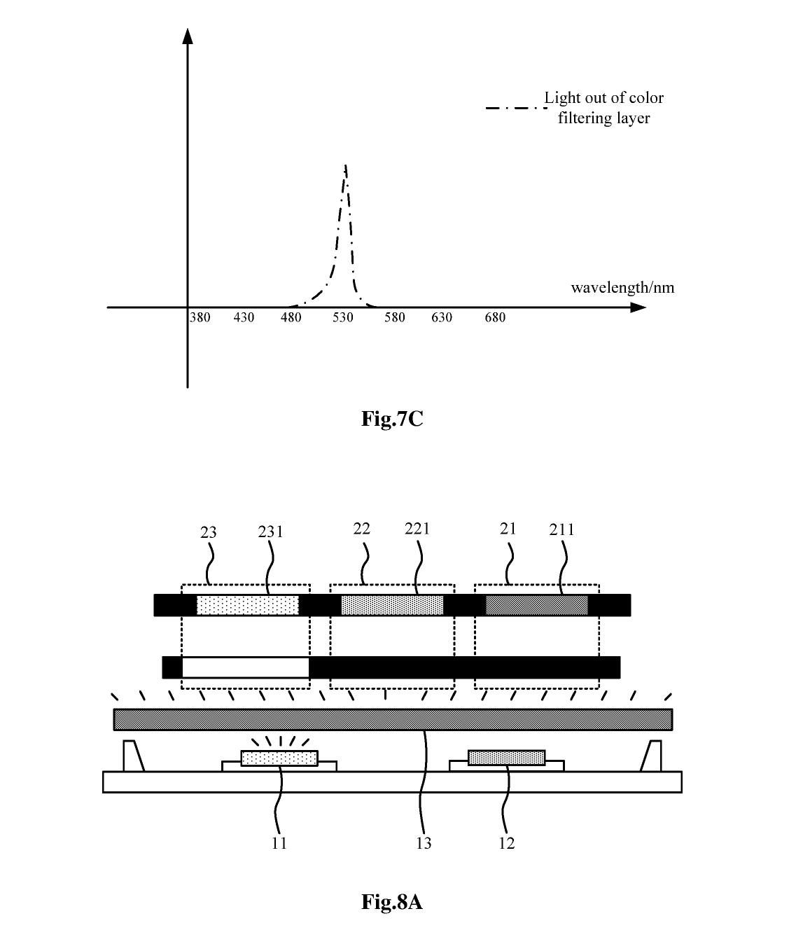

Optionally, as shown in FIG. 7A, if the target pixel is to display in green, the green liquid crystal cell 22 corresponding to the target pixel is controlled to be turned on in the second period of time and the blue liquid crystal cell 23 and the red liquid crystal cell 21 corresponding to the target pixel are controlled to be turned off.

In the second period of time, the green light source 12 is turned on. The green light may not excite the red light emitting layer 13 to emit red light; accordingly, in the second period of time, the backlight 1 emits only the green light.

Since in the second period of time only the green liquid crystal cell 22 corresponding to the green sub-pixel is turned on, the green light emitted by the backlight can enter the color filtering layer via the green liquid crystal cell 22. As shown in FIG. 7B, only light having a wavelength ranging from 450 nm to 620 nm can pass through the green filtering film 221 corresponding to the green liquid crystal cell 22 and the green light emitted by the backlight has a wavelength ranging from 490 nm to 560 nm, consequently, the green light can pass through the color filtering layer. As shown in FIG. 7C, light emitted by the pixel only contains the green light and no leakage of unwanted colorful light takes place.

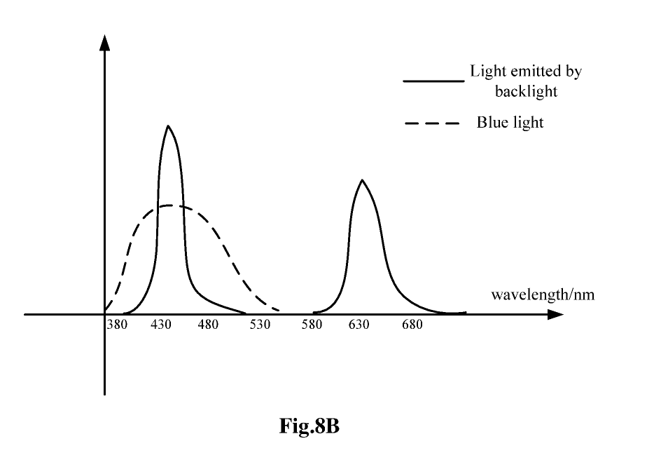

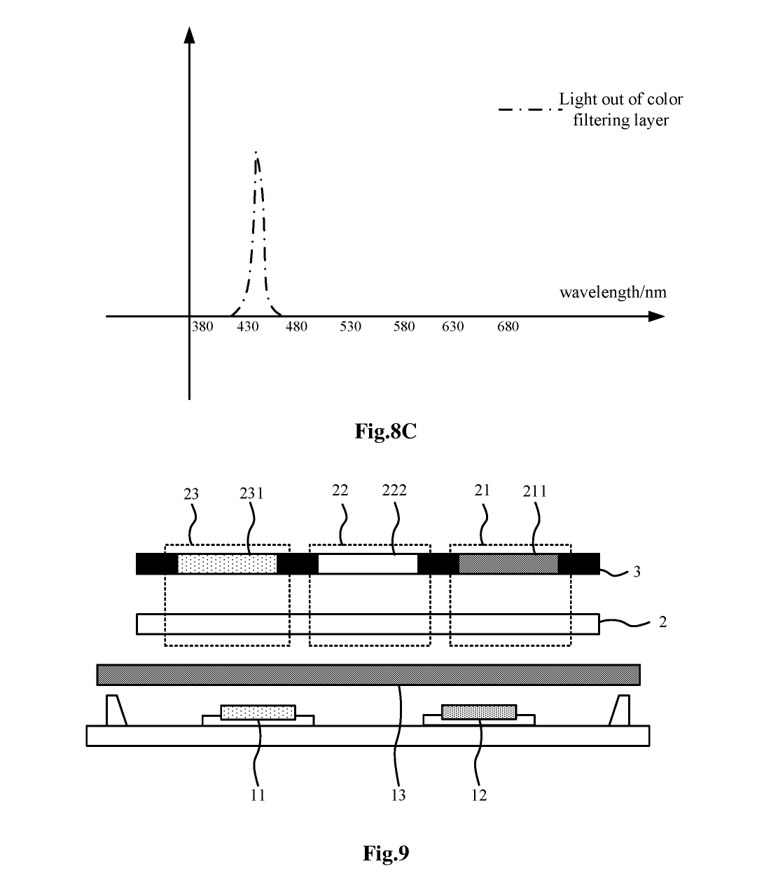

Optionally, as shown in FIG. 8A, if the target pixel is to display in blue, the blue liquid crystal cell 23 corresponding to the target pixel is controlled to be turned on in the first period of time and the red liquid crystal cell 21 and the green liquid crystal cell 22 corresponding to the target pixel are controlled to be turned off.

In the first period of time, the blue light source 11 is turned on. A part of blue light irradiates the red light emitting layer 13 and the red light emitting layer 13 is excited to emit red light, another part of blue light passes through the red light emitting layer 13. In the first period of time, the backlight 1 emits the red light and the blue light.

Since in the first period of time only the blue liquid crystal cell 23 corresponding to the blue sub-pixel is turned on, the red light and the blue light contained in light emitted by the backlight can both enter the color filtering layer via the blue liquid crystal cell 23. As shown in FIG. 8B, the blue filtering film 231 corresponding to the blue liquid crystal cell 23 may filter out light having a wavelength larger than 530 nm and light having a wavelength smaller than 380 nm, and the red light emitted by the backlight does not include any component having a wavelength larger than 530 nm or smaller than 380 nm, consequently, only the blue light emitted by the backlight can pass through the color filtering layer. As shown in FIG. 8C, light emitted by the pixel only contains the blue light and no leakage of unwanted colorful light takes place.

Optionally, the length of the first period of time equals to that of the second period of time.

According to the embodiment, the pixel displays in red and blue in the first period of time and displays in green in the second period of time, visual persistence is accordingly caused and a color to be displayed can be conveniently obtained through mixture.

Optionally, the length of each of the first period of time and the second period of time equals to 7 ms. Response time of the liquid crystal in related technologies is usually set as 14 ms, and here in the disclosure, the response time is decreased to half of 14 ms, which is easy to set and implement.

Optionally, the red light emitting layer 13 includes a red quantum dot material and/or a red fluorescent material, which have high stability and low cost.

As shown in FIG. 9, optionally, the display panel further includes a color filtering layer 3 located on the liquid crystal layer. The red liquid crystal cell 21 includes a red filtering film 211, the blue liquid crystal cell 23 includes a blue filtering film 231, and the green liquid crystal cell 22 includes a transparent thin film 222.

Since only the green light having a wavelength in a certain range among the whole wavelength range of green light can pass through the green filtering film 221, some of the green light emitted by the backlight may also be filtered out by the green filtering film 221. The transparent thin film 222 is arranged at a position of the color filtering layer corresponding to the green sub-pixel; therefore, the green light emitted by the backlight in the second period of time can completely pass through the color filtering layer and luminance of the pixel is enhanced.

The present disclosure further provides a display device, including the above mentioned display panel.

It should be noted that, according to embodiments of the present disclosure, the display device may be an electronic paper, a cellphone, a tablet computer, a television, a laptop computer, a digital photo frame, a navigator and any product or component having a displaying function.

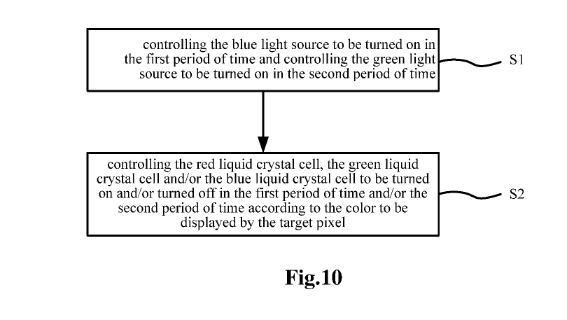

The present disclosure further provides a method for driving the above mentioned display panel. As shown in FIG. 10, the method includes following step s1 and S2.

The step S1 is to control a blue light source to be turned on in a first period of time and control a green light source to be turned on in a second period of time.

The step S2 is to control a red liquid crystal cell, a green liquid crystal cell and/or a blue liquid crystal cell to be turned on and/or turned off in the first period of time and/or the second period of time according to a color to be displayed by a target pixel.

Optionally, if the target pixel is to display in red, the red liquid crystal cell corresponding to the target pixel is controlled to be turned on in the first period of time, and the blue liquid crystal cell and the green liquid crystal cell corresponding to the target pixel are controlled to be turned off.

Optionally, if the target pixel is to display in green, the green liquid crystal cell corresponding to the target pixel is controlled to be turned on in the second period of time, and the blue liquid crystal cell and the red liquid crystal cell corresponding to the target pixel are controlled to be turned off.

Optionally, if the target pixel is to display in blue, the blue liquid crystal cell corresponding to the target pixel is controlled to be turned on in the first period of time, and the red liquid crystal cell and the green liquid crystal cell corresponding to the target pixel are controlled to be turned off.

In view of the problem that leakage of unwanted colorful light takes place when the display panel according to related technologies emits light, technical solutions of the present disclosure are described in conjunction with drawings. In the technical solutions of the present disclosure, the red light emitting layer cooperates with the blue light source and the green light source. When the blue light source is turned on, a part of blue light irradiates the red light emitting layer and excites the red light emitting layer to emit red light, and another part of blue light passes through the red light emitting layer, such that the backlight can emit red light and blue light in the first period of time; if a corresponding liquid crystal cell is turned on, lights entering a color filtering layer via the liquid crystal cell contain only the blue light and the red light. Since spectrums of the blue light and the red light do not overlap, each of the blue light and the red light emitted out of the color filtering layer barely contains light of other color. When the green light source is turned on, green light can pass through the red light emitting layer and the backlight emits the green light in the second period of time; if a corresponding liquid crystal cell is turned on, light entering the color filtering layer via the liquid crystal cell contains only the green light; hence, light passing through the color filtering layer contains only the green light and contains no other colorful light. In this way, leakage of unwanted colorful light is avoided, thereby increasing the gamut of the color displayed by the pixel.

It should be noted that, as shown in the drawings, sizes of layers and regions may be large for clearly showing the structures. It is understood that, if one element or layer is described as “located on” another element or layer, the one element or layer may directly contact with the another element or layer; alternatively, there exists an interlayer between the one element or layer and the another element or layer. Similarly, if one element or layer is described as “located below” another element or layer, the one element or layer may directly contact with the another element or layer; alternatively, there exists more than one interlayer or element between the one element or layer and the another element or layer. In addition, it is understood that if one layer or element is described as “located between” two layers or elements, the one layer or element may be a sole layer or element between the two layers or elements; alternatively, there may exist more than one interlayer or element between the two layers or elements in addition to the one layer or element.

In the specification, words “first” and “second” are merely for describing and do not indicate or suggest relative importance.

Those described are merely preferred embodiments of the present disclosure and are not intended to limit the present disclosure. The ordinary skilled in the art can make various modifications and changes to the present disclosure. Any modification, equivalent replacement and improvement without departing from the mind and principle of the present disclosure all fall in the protection scope of the present disclosure.

What is claimed is:

1. A display panel, comprising:
a backlight;
a red liquid crystal cell corresponding to a red sub-pixel of each pixel;
a green liquid crystal cell corresponding to a green sub-pixel of each pixel; and
a blue liquid crystal cell corresponding to a blue sub-pixel of each pixel;
wherein the red, green and blue liquid crystal cells are above the backlight;
wherein the backlight comprises a blue light source, a green light source and a red light emitting layer above the blue light source and the green light source, the red light emitting layer emits red light when being irradiated by blue light and does not emit any light when being irradiated by green light;
wherein the display panel further comprise:
a control circuit, configured to control the blue light source to be turned on in a first period of time, control the green light source to be turned on in a second period of time, and control the red liquid crystal cell, the green liquid crystal cell and/or the blue liquid crystal cell to be turned on and/or turned off in the first period of time and/or the second period of time according to a color to be displayed by a target pixel.

2. The display panel according to claim 1, wherein when the target pixel is to display in red, the red liquid crystal cell corresponding to the target pixel is controlled to be turned on in the first period of time, and the blue liquid crystal cell and the green liquid crystal cell corresponding to the target pixel are controlled to be turned off.

3. The display panel according to claim 1, wherein when the target pixel is to display in green, the green liquid crystal cell corresponding to the target pixel is controlled to be turned on in the second period of time, and the blue liquid crystal cell and the red liquid crystal cell corresponding to the target pixel are controlled to be turned off.

4. The display panel according to claim 1, wherein when the target pixel is to display in blue, the blue liquid crystal cell corresponding to the target pixel is controlled to be turned on in the first period of time, and the red liquid crystal cell and the green liquid crystal cell corresponding to the target pixel are controlled to be turned off.

5. The display panel according to claim 1, wherein a length of the first period of time equals to that of the second period of time.

6. The display panel according to claim 5, wherein the length of each of the first period of time and the second period of time equals to 7 ms.

7. The display panel according to claim 1, wherein a sum of the first period of time and the second period of time is smaller than duration of visual persistence.

8. The display panel according to claim 7, wherein a length of the first period of time equals to that of the second period of time.

9. The display panel according to claim 1, wherein the red light emitting layer comprises a red quantum dot material and/or a red fluorescent material.

10. The display panel according to claim 1, wherein the red liquid crystal cell comprises a red filtering film, the blue liquid crystal cell comprises a blue filtering film and the green liquid crystal cell comprises a transparent thin film.

11. The display panel according to claim 1, wherein each of the red liquid crystal cell, the blue liquid crystal cell and the green liquid crystal cell comprises a corresponding liquid crystal layer, and the control circuit controls states of liquid crystals in each liquid crystal layer to turn on and turn off each liquid crystal cell.

12. A display device, comprising: the display panel according to claim 1.

13. A method for driving the display panel according to claim 1, comprising:
controlling the blue light source to be turned on in the first period of time and controlling the green light source to be turned on in the second period of time; and
controlling the red liquid crystal cell, the green liquid crystal cell and/or the blue liquid crystal cell to be turned on and/or turned off in the first period of time and/or the second period of time according to the color to be displayed by the target pixel.

14. The method according to claim 13, wherein when the target pixel is to display in red, the red liquid crystal cell corresponding to the target pixel is controlled to be turned on in the first period of time, and the blue liquid crystal cell and the green liquid crystal cell corresponding to the target pixel are controlled to be turned off.

15. The method according to claim 13, wherein when the target pixel is to display in green, the green liquid crystal cell corresponding to the target pixel is controlled to be turned on in the second period of time, and the blue liquid crystal cell and the red liquid crystal cell corresponding to the target pixel are controlled to be turned off.

16. The method according to claim 13, wherein when the target pixel is to display in blue, the blue liquid crystal cell corresponding to the target pixel is controlled to be turned on in the first period of time, and the red liquid crystal cell and the green liquid crystal cell corresponding to the target pixel are controlled to be turned off.

17. The method according to claim 13, wherein a length of the first period of time equals to that of the second period of time.

18. The method according to claim 13, wherein a sum of the first period of time and the second period of time is smaller than duration of visual persistence.
